(19) United States
(12) Patent Application Publication
(10) Pub. No.: US 2008/0301863 A1
(43) Pub. Date: Dec. 11, 2008

(54) ELECTRICIAN'S VEST

(76) Inventors: Matthew Paul Goff, Syracuse, UT (US); Joshua Ken Ayres, Magna, UT (US)

Correspondence Address: BATEMAN IP LAW GROUP, P.O. BOX 1319, SALT LAKE CITY, UT, 84110, US

(21) Appl. No.: 12/134,974

(22) Filed: Jun. 6, 2008

Related U.S. Application Data
(60) Provisional application No. 60/942,991, filed on Jun. 8, 2007.

(51) Int. Cl. A41D 13/00; A41D 13/04; A41D 1/04; A41D 27/20; A62B 35/00

(52) U.S. Cl. 2/467; 2/51; 2/102; 2/247; 182/3

(57) ABSTRACT

An electrician's vest provides a more convenient vest configuration and facilitates easy access to the tools and supplies stored therein. The vest also incorporates a carrying handle and reinforcement webbing to increase the stiffness of the vest. The vest includes a back brace or back support belt which is allowed to move relative to the vest to keep the support brace in a proper position on the user's lower back while still allowing adequate freedom of movement.

### RELATED APPLICATIONS

The present application claims the benefit of U.S. Provisional Application Ser. No. 60/942,991, filed Jun. 8, 2007.

### BACKGROUND OF THE INVENTION

1. The Field of the Invention

The present invention relates to an electrician's vest. More specifically, the present invention relates to an improved electrician's vest having reinforcement and internal bracing to make the vest safer and more convenient to use. The vest may also include a hydration pack, carrying handle, and/or specialized pockets and compartments making the vest better suited for use by an electrician.

2. State of the Art

Currently, tool belts and vests are available, but do not provide a desired level of convenience and utility. Available vests may, in many cases, actually impede the motion of the person using the vest. Vests are typically used to carry a substantial amount of tools and supplies, resulting in the person carrying a substantial amount of added weight. The added weight combined with impeded motion may make the person more likely to become injured due to a restricted range of motion, or may even increase the risk of a person falling while working. Tool vests are often used where the wearer is working on a ladder, roof, or other such location. As such, an increased risk of falling or hampered motion presents a serious problem.

The available tool vests also do not provide an optimum configuration of pockets and storage compartments. Many vests are designed to be all purpose vests; being equally suited to various trades as well as hobby uses, and as such are not well suited to any particular use. Tool vests with inadequate configurations of pockets and storage compartments make it more difficult to carry and use the desired tools and equipment, increasing the time necessary to perform the task at hand. Additionally, a configuration of pockets or storage compartments which is awkward for a person to use may increase the risk of injury. A person working on a ladder, roof, or the like may lose their balance and fall while trying to retrieve or store items in the vest.

There is thus a need for a tool vest which overcomes the limitations of existing tool vests. There is a need for a tool vest which is more convenient to use. There is also a need for a tool vest which does not impede the motion of the person using the vest or which does not awkwardly apply loads to that person such that the vest is safer to use.

### SUMMARY OF THE INVENTION

It is an object of the present invention to provide an improved electrician's tool vest. According to one aspect of the invention, the vest incorporates reinforcement webbing to strengthen and stiffen the vest. According to another aspect of the invention, a vest is provided with an integral back brace which may move relative to the brace. According to another aspect of the invention, the vest may include an integral carrying handle. The vest may also include a hydration pack.

These and other aspects of the present invention are realized in an electrician's vest as shown and described in the following figures and related description.

### BRIEF DESCRIPTION OF THE DRAWINGS

Various embodiments of the present invention are shown and described in reference to the numbered drawings wherein:

FIG. 1 shows a front view of an electrician's vest according to the present invention;

FIG. 2 shows a back view of the vest of FIG. 1;

FIG. 3 shows a front view of the interior of the vest of FIG. 1;

FIG. 4 shows a side view of the back support belt of the vest of FIG. 1;

FIG. 5 shows a front view of another electrician's vest according to the present invention;

FIG. 6 shows a back view of the vest of FIG. 5;

FIG. 7 shows a front view of the interior of the vest of FIG. 5;

FIG. 8 shows a side view of the back support belt of the vest of FIG. 5; and

FIG. 9 shows a perspective view of a portion of the vest of FIG. 5 with an accessory pouch.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

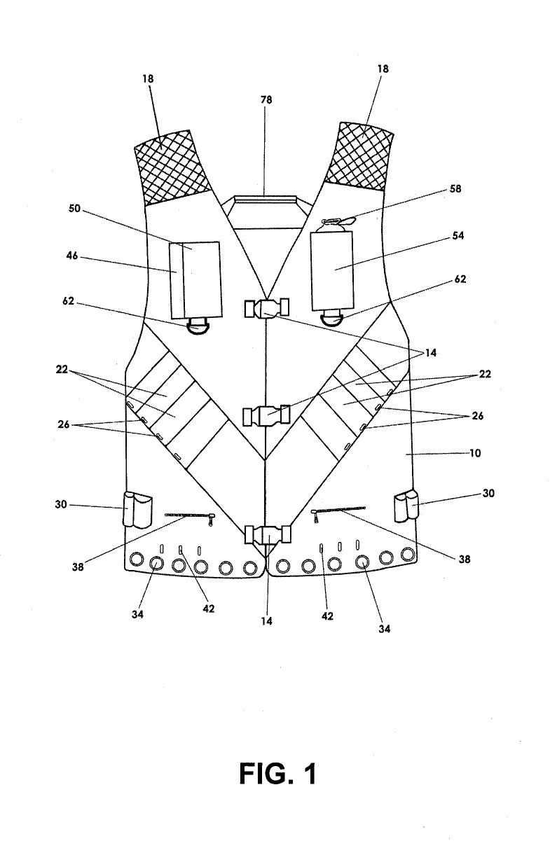

Turning now to FIG. 1, a front view of an electrician's vest according to the present invention is shown. The vest 10 includes a plurality of clips 14 to close the vest and secure it to a user. The shoulder areas 18 of the vest 10 are padded to make the vest more comfortable during use. The body of the vest 10 is constructed from materials commonly used to make tool vests or belts, such as leather, cordura, nylon, etc.

The vest 10 has pockets or compartments which are configured for carrying the tools and equipment commonly carried by an electrician. A plurality of hand tool pouches 22 (or pockets) are positioned on the front of the vest 10, and may be positioned at approximately a 45 degree angle as shown to allow hand tools to be easily placed into and removed from the pouches while working. The hand tool pouches 22 may include eyelets 26 or similar openings formed in the bottoms thereof to allow dirt and the like to fall out of the pouches. This keeps the pouches 22 from filling up with dirt, sawdust, etc. which makes it more difficult to keep tools in the pouches. It will be appreciated that available tool vests and belts will collect debris such as sawdust or dirt in the pockets and make the pockets less usable.

The vest 10 includes a number of sleeves 30 for holding screwdrivers, nut drivers, and other tools. Eyelets 34 may be placed across the bottom of the vest 10 to allow additional accessories, such as pouches or bags, to be attached to the bottom of the vest. A user may have a number of pouches filled with different nails, screws, etc. and may use these eyelets 34 to attach the bag necessary for a particular job.

Utility pockets 38 may be formed in the vest, allowing a variety of tools to be placed therein. These utility pockets 38 may also include eyelets 42 to allow dirt, sawdust, etc. to fall out of the pocket. The vest may include a pocket 46 for a pencil and a pocket 50 for a pad of paper, as well as a pocket 54 for safety glasses. The safety glasses pocket 54 may include a protective drawstring bag 58 to keep the glasses clean and free of scratches. D-rings 62 may be suspended from the various pockets or attached to other locations on the vest 10 and used to attach tools or equipment to the vest.

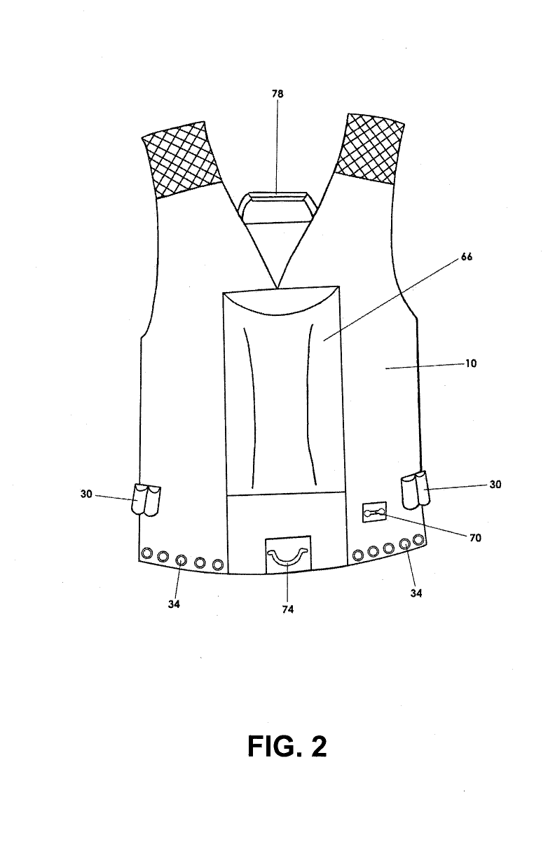

Turning now to FIG. 2, a back view of the vest 10 is shown. The vest 10 is formed with a large pouch 66 which may be used to hold a hydration pouch, allowing the user to carry a supply of water for consumption while working. A tape measure clip 70 and hammer loop 74 are provided on the back of the vest 10 and allow a user to carry these items in a location which is easy to reach and which does not interfere with the work being performed.

The vest 10 is also provided with a handle 78. The handle 78 allows the person to easily carry the vest while not in use, and may even be used to hang the vest for storage or transportation. Use of the handle keeps the vest in an upright position and thereby keeps the contents of the vest, such as tools, supplies, and equipment, safely stored in the various pouches and compartments. It also allows the vest to be used like a tool bag if desired.

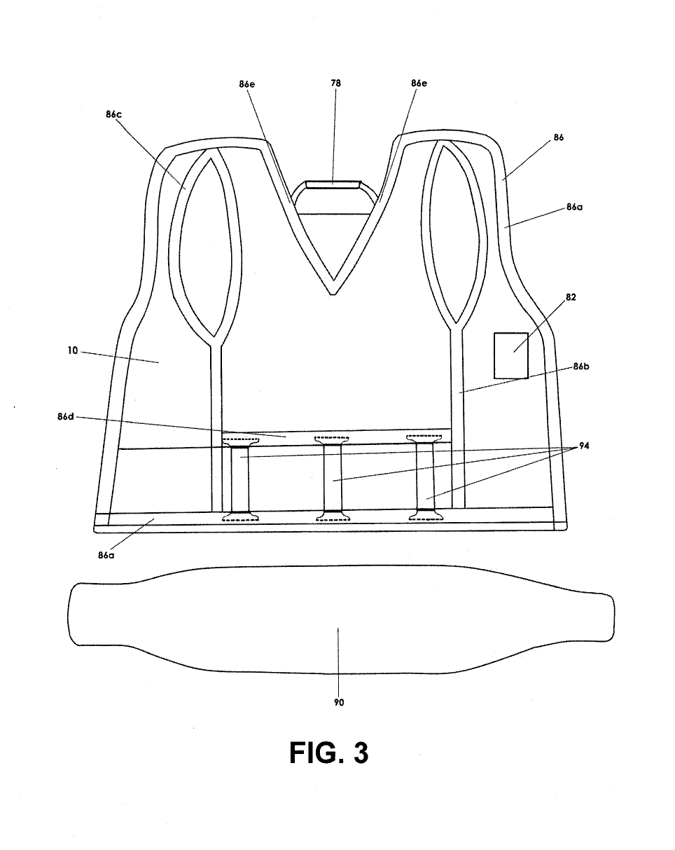

Turning now to FIG. 3, a front view of the interior of the vest 10 is shown. The vest may include interior pockets, such as a cell phone pocket 82. These interior pockets may be formed and used for items which are not frequently used or which need additional protection.

The vest 10 is formed with a strong webbing 86 similar to seat belt webbing. The webbing 86 may be a nylon webbing, etc. The webbing 86 may be placed around the edges of the vest, indicated at 86a, along the vest joints, indicated at 86b, around the arm openings 86c, and across the vest in various positions as indicated at 86d and 86e. The webbing 86 serves a few important functions. The webbing 86, especially around the edges of the vest, will reduce the wear on the vest and make the vest last longer. The webbing 86 will also strengthen and stiffen the vest 10. Webbing 86 placed across the vest such as shown at 86e may be particularly useful in maintaining the shape of the vest 10 when the vest is carried or hung by the handle 78. The webbing 86 may also be used to create a reinforced attachment point on the vest.

The vest 10 is also designed to include a back brace 90 (a back support belt). The back brace 90 is fastened around the lower back of the user with Velcro, but may also be fastened with a belt buckle or clip as is common for back braces. The brace 90 is attached to the vest 10, but is fastened to the waist of a user separately from the vest. The back brace 90 is attached to the vest 10, but can move relative to the vest to a certain degree. The back brace 90 is attached to vertical attachment strips 94 which are part of the vest 10. The attachment strips 94 may be attached to a section of the reinforcement webbing 86d.

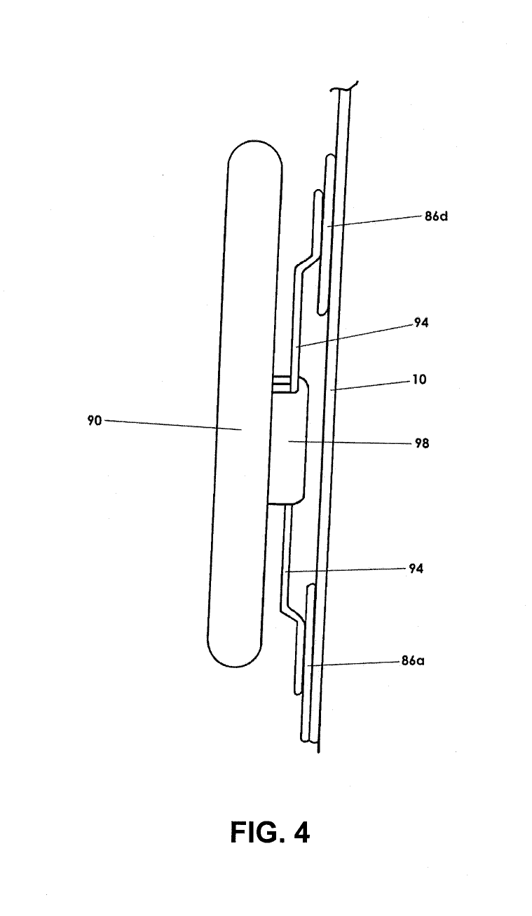

FIG. 4 shows a side view of the back brace 90 and its attachment to the vest 10. It can be seen how the attachment strips 94 are attached to the vest via the reinforcement webbing 86a, 86d, and how the back brace 90 is attached to the attachment strips by a loop 98. The attachment strips 94 may be a length of webbing, or may be a rigid plastic strip, or other type of strip. The loop 98 and attachment strip 94 allows the back brace 90 to slide vertically relative to the vest 10. This allows the vest to move as the user raises their arms, bends from side to side, or is otherwise working while allowing the back brace to remain in the same position on the user's back.

The back brace 90 thus provides an additional safety feature by providing a brace, and by maintaining the brace in a proper position while the user works. It will be appreciated that the back brace may also be designed to carry some of the weight of the vest when the user is in a resting position; i.e. when not in a position which lifts the vest. The back brace 90 thus works in combination with the reinforcement webbing 86 to provide a vest 10 which is stiff enough to adequately support the tools and equipment carried in the vest and to protect the user from injury, and yet which is still comfortable to use and which does overly restrict movement of the user. The stiffness of the vest 10 also allows the vest to be carried by the handle 78 without excessive deformation of the shape of the vest, which helps keep the tools and supplies carried in the vest from falling out of the vest while in transit. The rigidity of the vest 10 also helps properly support the tools and supplies carried in the vest during use, making these more readily available during use.

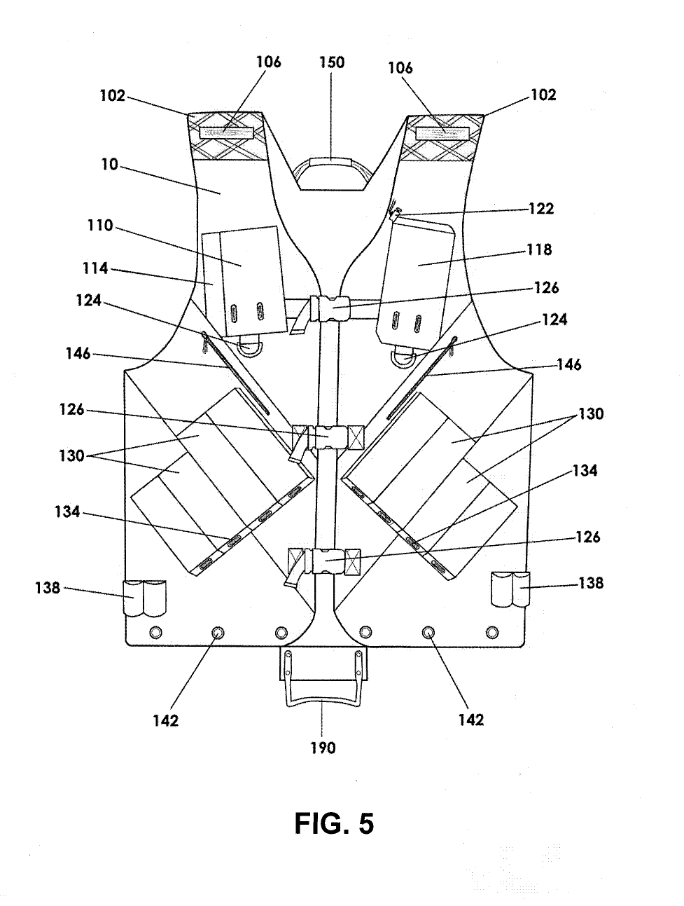

Turning now to FIGS. 5 through 8, another electrician's tool vest similar to that of FIGS. 1-4 is shown. The vest of FIGS. 5-8 contains structures which are similar to those of FIGS. 1-4 and which would be understood to perform similar functions. The vest 10 includes padded shoulder straps 102. The shoulder straps 102 have strips of elastic 106 attached thereto. The elastic strips 106 are attached at the end and may be used to hold a drinking tube of a hydration pack or a radio microphone to the shoulder straps 102 to place the desired item in a convenient location close to the user's head. A pocket 110 is sized to hold a pad of paper and a pocket 114 is sized to hold a pen. Another pocket 118 includes an integrated bag for safety glasses and a drawstring 122 to close the bag to prevent damage to or loss of the safety glasses. D-shaped rings 124 may be attached to the vest to allow other tools or equipment to be attached thereto. Clips 126 are used to fasten the vest around the user.

The vest includes pockets 130 which are sized to receive larger hand tools such as pliers. The pockets 130 have eyelets 134 in the bottoms thereof to allow debris to fall from the pocket. Tool loops 138 are included for storing smaller hand tools such as screwdrivers. A plurality of eyelets 142 are secured around the bottom of the vest 10 and may be used to attach accessories such as additional pockets or the like. Zippered pockets 146 are also provided.

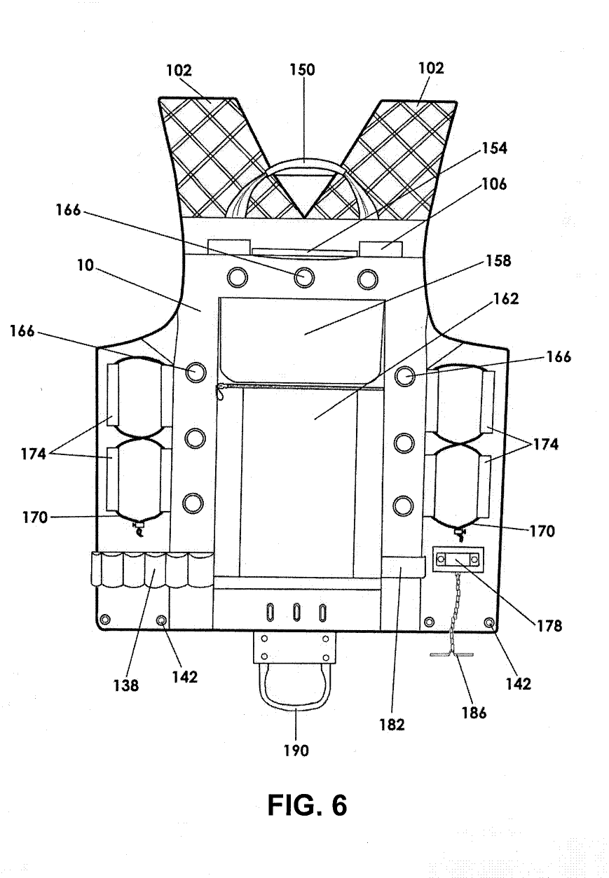

Turning now to FIG. 6, a back view of the vest 10 is shown. The vest 10 includes a carrying handle 150 which makes it easier to carry the vest without spilling the tools or supplies stored therein. The carrying handle 150 is attached to a vest framework made of nylon webbing to provide structural integrity to the vest 10. The vest 10 includes a safety harness access hole 154 which is open to the interior of the vest. The access hole 154 allows a safety line to be connected through the back of the vest to a safety harness worn by the user. It is desirable that a user is able to properly wear a safety harness beneath the vest 10 when such is required.

A larger pocket 158 is provided which can hold a 1-2 liter hydration pack. Another larger pocket 162 can hold test equipment, gloves, or other larger items. A number of larger eyelets 166 are provided to allow for increased air flow through the vest, making the vest more comfortable for the user. Elastic cords 170 and corresponding loops 174 on the sides of the vest 10 may be used to accommodate smaller vest users. The elastic cords 170 are tightened to make the sides of the vest smaller. The vest 10 also includes a tape measure clip 178, a loop 182 for securing large tools, a chain for holding rolls of tape, and a hammer loop 190.

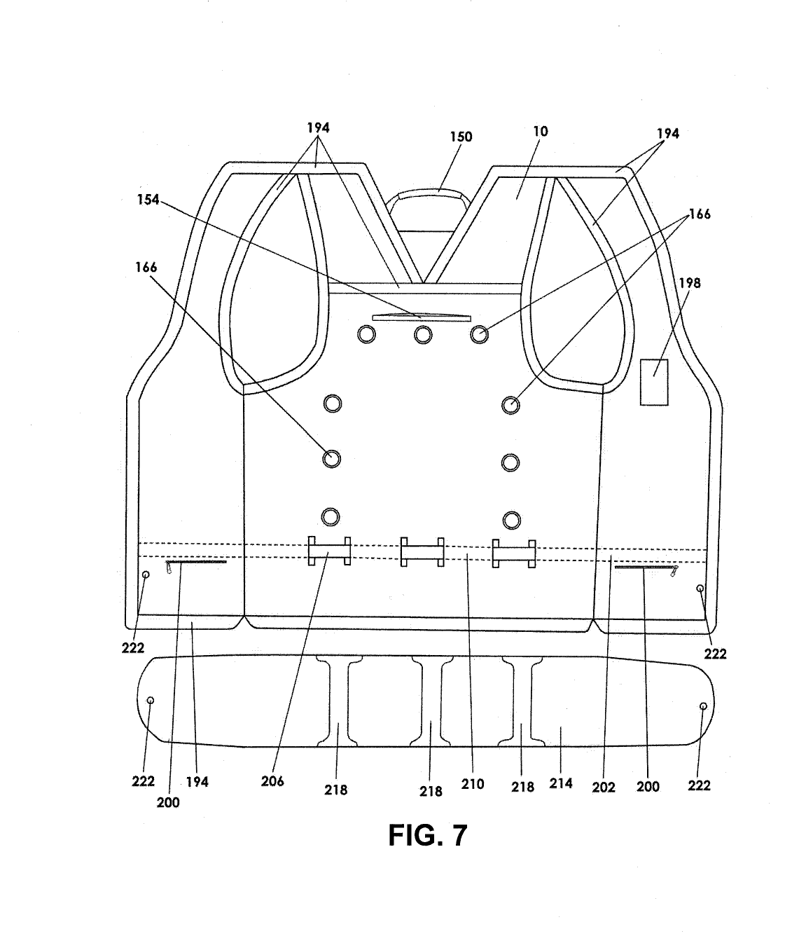

FIG. 7 shows the interior of the vest 10. The vest 10 is made stronger by a framework of woven nylon 194. The nylon 194 is preferably a heavy woven nylon strap similar to that used for automobile seat belts. The nylon 194 is attached around the edges of the vest 10 to strengthen the vest. The nylon framework 194 makes the vest retain its shape better and resist sagging during use and when the vest is carried by the handle 150. A pocket 198 is provided on the interior of the vest 10 for cell phones or the like. Zippered pockets 200 may also be provided as a safe storage area which better protects items such as electronics from damage or loss.

The vest 10 is formed with a nylon strap 202 which runs horizontally along the waist of the belt. The strap 202 runs along the part of the vest which would be adjacent a user's waist, and includes exposed loop portions 206 which are not sewn against the surface of the vest 10 and portions 210 which are fastened to the vest. The fastened portions 210 may be hidden beneath the liner of the vest or may be exposed. A back support belt 214 is formed as part of the vest 10. The back support belt 214 includes a number of ribs 218 which span the surface of the belt and which are attached to the belt at the ends thereof. There are a number of ribs 218 to match the loop portions 206 of the strap 202 and the ribs 218 pass through the loops 206 of the strap 202.

The engagement of the ribs 218 and loops 206 of strap 202 allow the belt 214 to move vertically and twist somewhat relative to the vest 10. In use, the back support belt 214 serves as a conventional back brace and also carries some of the weight of the vest 10. When a user raises their arms to work, the ribs 218 and loops 206 allow the vest to shift so as to allow for freedom of movement and so as to not restrict the user while working. Corresponding snaps 222 on the vest 10 and belt 214 attach the belt to the vest while the vest is not in use, further stabilizing the vest.

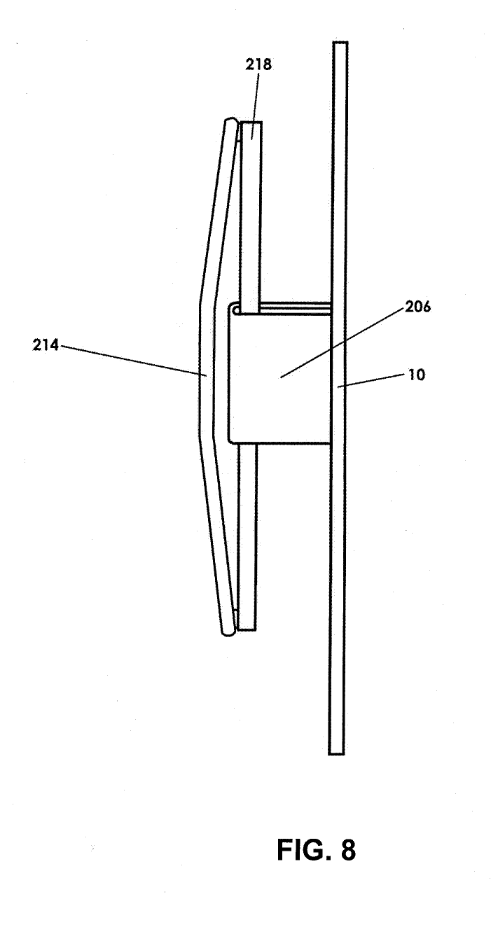

FIG. 8 shows a side view of the back brace belt 214, illustrating how the ribs 218 and loops 206 interact to provide for motion of the belt relative to the vest 10. Typically, the ribs 218 are formed from a relatively rigid material which has a relatively low coefficient of friction so as to facilitate sliding between the belt 214 and vest 10. Thus, the ribs 218 may typically be made of polypropylene, polyethylene, or other similar materials. The material used to make the ribs 218 should not be brittle so as to reduce the chance of breaking the ribs when using the vest 10.

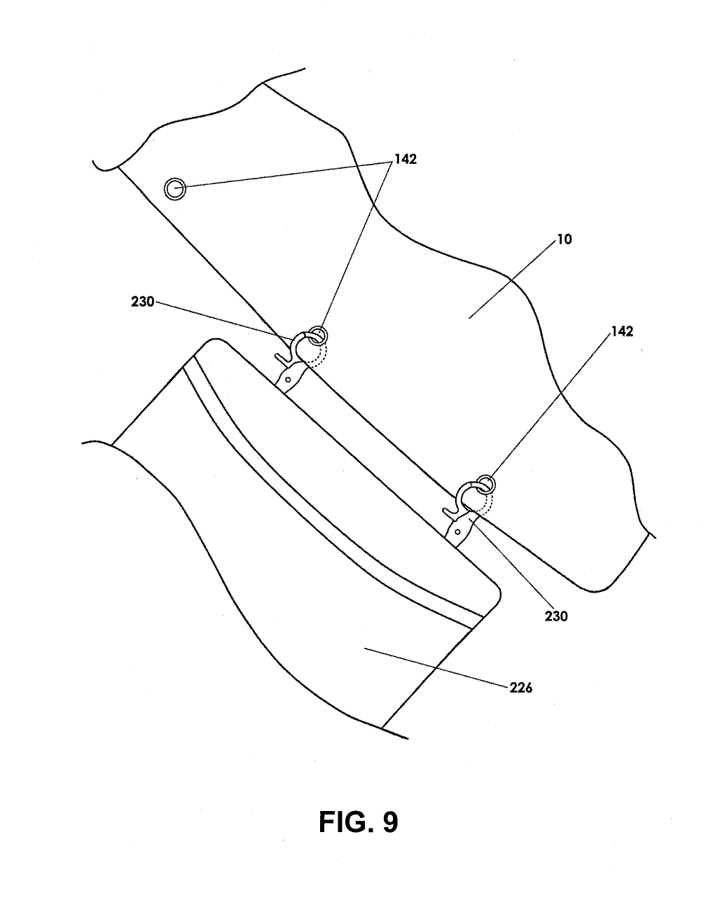

FIG. 9 shows a perspective view of a portion of the vest 10 of FIG. 5 and a removable storage pouch 226 which may be attached thereto. The accessory pouch 226 is attached to the eyelets 142 with clips 230, such as are commonly used to attach shoulder straps to bags. The use of eyelets 142 and clips 230 to attach the removable pouches 226 is advantageous as it allows these pouches 226 to be quickly removed from or attached to the vest 10 without removing the vest from a person wearing the vest. Tool belts which have removable pouches require that the person remove the belt and slide pouches on or off the open belt.

There is thus disclosed an improved electrician's tool vest. It will be appreciated that numerous changes may be made to the present invention without departing from the scope of the claims.

What is claimed is:

1. A tool vest comprising:
a vest wearable by a person, the vest having fasteners for closing the vest and securing the vest to the person; and
a plurality of pockets disposed on the vest configured for receiving tools.

2. The vest of claim 1, wherein the pockets comprise holes in the bottoms thereof configured for allowing debris to fall out of the pocket.

3. The vest of claim 1, wherein the vest further comprises a handle attached to the back side of the vest and configured for carrying the vest.

4. The vest of claim 1, wherein the vest comprises reinforcement webbing disposed therein, the webbing being configured to increase the stiffness of the vest to facilitate the carrying of the vest by a handle.

5. The vest of claim 4, wherein the webbing is disposed around the edges of the vest.

6. The vest of claim 4, wherein the webbing extends across the middle of the vest.

7. The vest of claim 6, wherein the vest comprises eyelets disposed therein to allow air movement through the vest.

8. The vest of claim 1, wherein the vest comprises a back brace belt.

9. The vest of claim 8, wherein the back brace belt is fastened around the waist of a person independent of fastening the vest closed around the torso of the person.

10. The vest of claim 9, wherein the back brace belt is attached to the vest so as to allow vertical movement of the back brace belt relative to the vest.

11. The vest of claim 10, wherein the back brace belt comprises a plurality of vertically disposed ribs disposed along a height thereof and attached at the ends thereof and wherein the vest comprises loops formed thereon, the ribs passing vertically through the loops so as to allow vertical movement of the back brace belt relative to the vest.

12. The vest of claim 1, wherein the vest further comprises an opening formed therethrough, the opening being configured for allowing a person to wear a safety harness underneath and to pass a safety line through the vest for attachment to the safety harness.

13. A safety system comprising the vest of claim 1 and further comprising a safety harness, and wherein the vest is configured for wearing by a user over the safety harness and wherein the vest comprises an opening therein configured for allowing a safety line to pass therethrough for attachment to the safety harness.

14. A tool vest wearable by a person, the vest comprising:
a plurality of storage compartments configured for receiving tools and supplies;
fasteners configured for securing the vest to a person;
a back brace belt, the back brace belt being attached to the inside of the vest so as to be placed adjacent the waist of a person wearing the vest, the back brace belt being movable relative to the vest in a vertical direction.

15. The vest of claim 14, wherein the back brace belt is fastened around the waist of a person wearing the vest independent of fastening the vest around the person.

16. The vest of claim 15, wherein the back brace belt comprises vertically disposed ribs attached to a side of the belt, the ribs being attached at the ends thereof and free along a middle portion thereof, and wherein the vest comprises a corresponding number of vertical openings disposed on the inside of the vest, and wherein each of the ribs passes through one of the openings so as to secure the belt to the vest while allowing vertical movement of the belt relative to the vest.

17. The vest of claim 14, wherein the back brace belt has first fastener elements disposed thereon and wherein the vest has second fastener elements disposed thereon, and wherein the first fastener elements may be secured to the second fastener elements to fix the position of the back brace belt relative to the vest.

18. The vest of claim 14, wherein the vest comprises an opening formed therethrough, the opening being configured for allowing a safety line to pass through the opening and be connected to a safety harness worn by a user underneath the vest.

19. The vest of claim 14, wherein the vest comprises a pouch configured for carrying a hydration pack.

20. The vest of claim 19, further comprising a hydration pack.

21. The vest of claim 14, wherein the vest comprises a handle formed thereon, the handle being configured for carrying the vest in a generally upright position.

22. The vest of claim 14, wherein the vest comprises openings formed therethrough configured for allowing air circulation through the vest.
